(19) United States
(12) Patent Application Publication
(10) Pub. No.: US 2026/0346651 A1
(43) Pub. Date: Nov. 5, 2026

(54) TIRE COMPRISING TREAD BLOCKS COMPRISING ELONGATE INCISIONS

(71) Applicant: COMPAGNIE GENERALE DES ETABLISSEMENTS MICHELIN, Clermont-Ferrand (FR)

(72) Inventor: OLIVIER FRANCOIS, Clermont-Ferrand (FR)

(21) Appl. No.: 19/121,521

(22) PCT Filed: Sep. 19, 2023
(86) PCT No.: PCT/EP2023/075713

§ 371 Date: Apr. 16, 2025

(30) Foreign Application Priority Data
Oct. 18, 2022 (FR) FR2210731

(51) Int. Cl. B60C 11/12; B60C 11/03

(52) U.S. Cl. CPC B60C 11/1204; B60C 11/0306; B60C 11/1236; B60C 2011/1254; B60C 2200/14

(57) ABSTRACT

The tire comprises a tread comprising a sipe (82), called elongate sipe, provided in a tread block (20) and comprising: a central portion (84) arranged between dimensioning points (94, 96) defining the slenderness direction (Ei) of the elongate sipe (82); and an elongation portion (86, 88) arranged between one of the dimensioning points (94, 96) and one of the blind ends (90, 92). The central portion (84) and the elongation portion (86, 88) are arranged such that, when moving along the elongate sipe (82) from the elongation portion (86, 88) towards the central portion (84), the direction of movement is changed with respect to the slenderness direction (Ei) when passing through the dimensioning point (94, 96) defining the slenderness direction (Ei). The ratio of the curvilinear lengths of the elongation portion (86, 88) to the central portion (84) is strictly less than 1.0.

The present invention relates to a tyre. A tyre is understood to mean a casing intended to form a cavity by cooperating with a support element, for example, a rim, with this cavity being able to be pressurized to a pressure higher than atmospheric pressure. A tyre according to the invention has a structure of substantially toroidal shape exhibiting symmetry of revolution about a main axis of the tyre.

Racing tyres are known from the prior art that are intended for rally events where vehicles fitted with such tyres run on rocky ground. Known tyres are the MICHELIN LATITUDE CROSS® tyres.

These tyres comprise a tread comprising a plurality of tread blocks and a plurality of cuts. Each tread block comprises a sipe provided in said tread block.

The appearance of cracks and even chunking at the ends of the sipes has been observed during rally events, also called special stages. These cracks and the chunking occur even more quickly when the special stages are long and run on relatively aggressive ground and at high temperatures. This chunking, although not dangerous, decreases the service life of the tyre.

The aim of the invention is to make the tyre less sensitive to the appearance of cracks and chunking and to thus increase the service life of the tyre, notably during intensive use, for example, on aggressive ground and/or at high temperatures.

To this end, the subject matter of the invention is a tyre comprising a tread comprising a plurality of tread blocks delimited by a plurality of cuts, at least one tread block of the plurality of tread blocks comprises a sipe, called elongate sipe, with the elongate sipe being provided in said tread block, the elongate sipe comprising:
first and second blind ends;
first and second dimensioning points defining a slenderness direction of the elongate sipe and a maximum dimension of the elongate sipe in the slenderness direction of the elongate sipe, each first and second dimensioning point being distinct from each first and second blind end;
   the first and second blind ends and the first and second dimensioning points being arranged so as to define:
a central portion of the elongate sipe arranged between the first and second dimensioning points defining the slenderness direction of the elongate sipe;
at least one elongation portion of the elongate sipe arranged between one of the first and second dimensioning points defining the slenderness direction of the elongate sipe and one of the first and second blind ends, with the one or each elongation portion being connected to the central portion;
   the central portion and the one or each elongation portion being arranged such that, when moving along the elongate sipe from the one or each elongation portion towards the central portion, the direction of movement is changed with respect to the slenderness direction of the elongate sipe when passing through said dimensioning point of the elongate sipe defining the slenderness direction of the elongate sipe; the ratio of:
the curvilinear length of the one or each elongation portion; to
the curvilinear length of the central portion,
   is strictly less than 1.0.

By virtue of the elongation portion, the first and second dimensioning points are distinct from the first and second ends of the sipe. Thus, the first and second ends of the sipe, due to their arrangement with respect to the first and second dimensioning points, are farther from the edges of the tread block in which the sipe is provided, which limits the appearance of cracks. Furthermore, by being blind, the first and second ends of the sipe do not emerge into the cuts, which also protects them from the appearance of cracks. In other words, the first and second ends of the sipe are not connected to the cuts.

Due to the ratio of the curvilinear lengths of the elongation portion to the central portion, the invention covers the elongation portions whose curvilinear length is strictly less than the curvilinear length of the central portion. In other words, the elongation portion provides a performance gain that even though it is significant, remains in addition to the performance imparted by the central portion.

The elongation portion allows the curvilinear length of the sipe to be increased compared to a sipe comprising only one portion in which the first and second dimensioning points coincide with the first and second ends of the sipe. In other words, in the invention, the total curvilinear length of the elongate sipe between the first and second blind ends is strictly greater than the curvilinear length of the elongate sipe between the first and second dimensioning points. By changing the direction of movement with respect to the slenderness direction of the elongate sipe when passing through said dimensioning point, it is possible to benefit from the space of the tread block in order to arrange the elongation portion away from at least one edge of the tread block. This elongation portion allows the heat exchange surface area to be increased between the tread and the air and therefore allows the tread block to be cooled more effectively than the tyre of the prior art. This cooling limits any increase in temperature of the tread block, notably during long special stages, running on relatively aggressive ground and/or at high temperatures, and therefore delays the appearance of cracks by preserving the properties of the one or more constituent materials of the tread block.

Finally, the presence of the elongation portion allows edges to be created in several directions, unlike a straight sipe, which promotes the transmission of forces, allows the driveability of the tyre to be increased, and increases its versatility in the various load directions.

The slenderness direction is the straight direction joining the first and second dimensioning points. The first and second dimensioning points define a maximum dimension of the elongate sipe in the slenderness direction, which means that the elongate sipe is inscribed between first and second straight lines that are substantially parallel to each other and respectively pass through each first and second dimensioning point, with these first and second straight lines being perpendicular to the slenderness direction.

The slenderness direction of the sipe can travel in two directions. A direction is changed when moving along the elongate sipe and when the component of the movement in the slenderness direction of the sipe changes from one of the two directions of the slenderness direction of the sipe to the other one of the two directions of the slenderness direction of the sipe.

The first and second blind ends delimit the total maximum curvilinear length of the elongate sipe. In other words, if the sipe has more than two blind ends, for example, in the case of a branched sipe, the first and second blind ends are those defining the longest curvilinear length, referred to as the maximum curvilinear length.

“Blind” is understood to mean, as is well known to a person skilled in the art, that each first and second end is separated from each cut adjacent to the tread block by a non-zero thickness of the one or more constituent materials of the tread block. Thus, as specified above, the first and second ends of the sipe do not emerge into the cuts, which means that, for any point located over the radial height of each first and second end, a non-zero thickness exists for the one or more constituent materials of the tread block separating this point and its orthogonal projection on each face of the tread block delimiting each adjacent cut.

Any end of the sipe other than the first and second blind ends will be referred to as blind in the event that said other end complies with the features described in the preceding paragraph. For example, a branched sipe can have blind ends other than the first and second blind ends.

Each elongation portion connected to the central portion means that the elongate sipe is continuous between the one or each elongation portion and the central portion. The one or each elongation portion and the central portion are not separate from each other, for example, separated by a portion of the tread block. In other words, when the sipe is radially closed by the ground over which the tyre is running, air can freely circulate between the one or each elongation portion and the central portion, and vice versa.

A tread block generally has a plurality of edges defining a contour of the tread block. These edges can be straight or curvilinear. A distinction is made between a leading edge, a trailing edge and side edges. The leading edge is the edge that firstly comes into contact with the ground when the tyre rotates in its direction of forwards rotation. The trailing edge is the edge that lastly comes into contact with the ground when the tyre rotates in its direction of forwards rotation. The side edges are the edges that connect the leading and trailing edges.

The angle between two directions is the angle that, in terms of an absolute value, is the smallest of the two angles defined between a first one of the two directions and the second one of the two directions.

The average direction formed by an edge is the straight direction connecting the two ends of the edge.

In the case of a racing tyre, the axial width of the tread is determined on an unfitted and uninflated tyre by measuring the axial distance between the edges forming the first and second axial edges of the tread, with these axial edges forming the boundary between the tread and the sidewalls of the tyre. Each of these first and second axial edges include the side edges of the axially outermost tread blocks of the tread.

In the case of a tyre that is not intended for racing, the tread surface area on a tyre fitted on a measuring rim and inflated to its nominal pressure (250 kPa or 290 kPa depending on whether it is a standard or reinforced tyre) can be determined, within the meaning of the ETRTO (“European Tyre and Rim Technical Organisation”) Standards Manual, 2021, as being the surface area in contact with the ground when the tyre is loaded to 80% of its loading capacity within the meaning of the ETRTO Standards Manual, 2021, with this load then representing the commonly encountered use conditions. Another method can involve, on an unloaded tyre that is fitted on a measuring rim and inflated to the nominal pressure (250 kPa or 290 kPa depending on whether it is a standard or reinforced tyre) within the meaning of the ETRTO Standards Manual, 2021, determining the axial limits of the tread surface, for example, by considering that each axial limit of the tread surface passes through the point at which the angle between the tangent to the tread surface and a straight line parallel to the axial direction passing through this point is equal to 30°. When, in a meridian section plane, there are several points at which said angle is equal, in terms of absolute value, to 30°, the radially outermost point is used.

The invention particularly relates to racing tyres for motor vehicles. Racing is understood to mean officially timed events and not free running events, sometimes referred to as “track days” or “HDPE” (High Driving Performance Events), which covers events that are not officially timed.

The invention relates, very specifically and very preferably, to tyres for rally racing and more preferably for rally racing at least on rocky and/or gravelly and/or muddy ground and very preferably for rally racing on rocky ground.

The tyre according to the invention has a substantially toroidal shape about an axis of revolution that is substantially coincident with the axis of rotation of the tyre. This axis of revolution defines three directions conventionally used by a person skilled in the art: an axial direction, a circumferential direction and a radial direction.

The tread surface of the tyre is the surface of the tread via which the tyre is made to come into contact with the ground when it runs on this ground.

The axial direction is understood to mean the direction substantially parallel to the axis of revolution of the tyre, i.e., the axis of rotation of the tyre.

The circumferential direction is understood to mean the direction that is substantially perpendicular both to the axial direction and to a radius of the tyre (in other words, tangent to a circle centred on the axis of rotation of the tyre).

The radial direction is understood to mean the direction along a radius of the tyre, i.e., any direction that intersects the axis of rotation of the tyre and is substantially perpendicular to this axis.

The median plane of the tyre (denoted M) is understood to mean the plane perpendicular to the axis of rotation of the tyre, which is located axially mid-way between the two beads and passes through the axial centre of the crown reinforcement.

The equatorial circumferential surface of the tyre is understood to mean, in a meridian section plane, the surface passing through the equator of the tyre, perpendicular to the median plane and to the radial direction. The equator of the tyre is, in a meridian section plane (the plane perpendicular to the circumferential direction and parallel to the radial and axial directions), the axis that is parallel to the axis of rotation of the tyre and is located at an equal distance between the radially outermost point of the tread that is intended to be in contact with the ground and the radially innermost point of the tyre that is intended to be in contact with a support, for example, a rim.

The meridian plane is understood to mean a plane that is parallel to and contains the axis of rotation of the tyre and is perpendicular to the circumferential direction.

“Radially inside” and “radially outside”, respectively, mean closer to the axis of rotation of the tyre and farther away from the axis of rotation of the tyre, respectively. “Axially inside” and “axially outside”, respectively, mean closer to the median plane of the tyre and farther away from the median plane of the tyre, respectively.

A bead is understood to mean the radial portion of the tyre intended to allow the tyre to be attached to a mounting support, for example, a wheel comprising a rim. Thus, each bead is notably intended to be in contact with a flange of the rim allowing it to be attached.

Any range of values denoted by the expression “between a and b” represents the range of values ranging from more than a to less than b (i.e., limits a and b excluded), whereas any range of values denoted by the expression “from a to b” means the range of values ranging from a up to b (i.e., including the strict limits a and b).

A cut denotes either a groove or a sipe and forms a space emerging onto the tread surface.

A sipe or a groove has, on the tread surface, two main characteristic dimensions: a width and a curvilinear length, such that the curvilinear length is at least equal to twice the width. A sipe or a groove is therefore delimited by at least two main lateral faces determining its curvilinear length and connected by a bottom face, with the two main lateral faces being separated from one another by a non-zero distance referred to as the width of the cut.

On a new tyre, the width of a cut is the maximum distance between the two main lateral faces measured, when the cut is not chamfered, at a radial dimension coincident with the tread surface and, when the cut is chamfered, at the radially outermost radial dimension of the cut and radially innermost dimension of the chamfer. The width is measured substantially perpendicular to the main lateral faces.

A sipe is such that the distance between the main lateral faces is suitable for allowing the main lateral faces that delimit said sipe to come into at least partial contact in the contact area, notably when the tyre is new.

A groove is such that the distance between the main lateral faces is such that these main lateral faces cannot come into contact with one another, notably when the tyre is new.

A cut can be transverse or circumferential.

A transverse cut is such that the cut extends in an average direction that forms an angle with the circumferential direction of the tyre that is strictly greater than 30°, preferably greater than or equal to 45°. The average direction is the shortest curve that joins the two ends of the cut and is parallel to the tread surface. A transverse cut can be continuous, i.e., not interrupted by a tread block or another cut, such that the two main lateral faces determining its length are uninterrupted over the length of the transverse cut. A transverse cut also can be discontinuous, i.e., interrupted by one or more tread blocks and/or one or more cuts, such that the two main lateral faces determining its length are interrupted by one or more tread blocks and/or one or more cuts.

A circumferential cut is such that the cut extends in an average direction that forms an angle with the circumferential direction of the tyre that is less than or equal to 30°, preferably less than or equal to 10°. The average direction is the shortest curve that joins the two ends of the cut and is parallel to the tread surface. In the case of a continuous circumferential cut, the two ends coincide with each other and are joined by a curve that makes a full circuit around the tyre. A transverse cut can be continuous, i.e., not interrupted by a tread block or another cut, such that the two main lateral faces determining its length are uninterrupted over a full circuit around the tyre. A circumferential cut also can be discontinuous, i.e., interrupted by one or more tread blocks and/or one or more cuts, such that the two main lateral faces determining its length are interrupted by one or more tread blocks and/or one or more cuts over a full circuit around the tyre.

In some embodiments, the one or each circumferential cut is chamfered. A chamfer of a circumferential cut can be a straight chamfer or a rounded chamfer. A straight chamfer is formed by a flat face that is inclined with respect to the axially inner and outer face that it extends as far as the axially inner or outer edge axially delimiting the circumferential cut. A rounded chamfer is formed by a curved face that tangentially merges into the axially inner or outer face that it extends. A chamfer of a circumferential cut is characterized by a height and a width that are equal to the radial distance and to the axial distance, respectively, between the common point shared by the axially inner or outer face extended by the chamfer, and the axially inner or outer edge that axially delimits the circumferential cut.

In some embodiments, the one or each transverse cut is chamfered. In other words, each transverse cut is radially delimited by faces that circumferentially delimit said transverse cut and are connected to one another by a bottom face that delimits said transverse cut radially inwards. A chamfer of a transverse cut can be a straight chamfer or a rounded chamfer. A straight chamfer is formed by a flat face that is inclined with respect to the face that it extends as far as the edge that circumferentially delimits the transverse cut. A rounded chamfer is formed by a curved face that tangentially merges into the face that it extends. A chamfer of a transverse cut is characterized by a height and a width that are respectively equal to the radial distance and to the distance in a direction perpendicular to the faces between the common point shared by the face extended by the chamfer, and the edge that circumferentially delimits the transverse cut.

On a new tyre, the depth of a cut is the maximum radial distance between the bottom of the cut and its projection onto the ground when the tyre is running. The maximum value for the depths of the cuts is referred to as the tread pattern height.

In embodiments, particularly suitable for racing tyres, notably rally racing tyres, the tyre according to the invention is a tyre with an imposed inner side and outer side when fitted on the vehicle. This means that the tyre is designed such that one of its sides is arranged on the inner side and the other one of its sides is arranged on the outer side. The expression “outer side” is understood to mean the side of the tyre that is entirely visible from the outside of the vehicle when the tyre is fitted on the vehicle. “Inner side” is understood to mean the side of the tyre that faces the wheel arch of the vehicle on which it is fitted. Generally, the tyre has a marking indicating the inner side and the outer side.

In preferred embodiments, the slenderness of the elongate sipe is greater than or equal to 1.5, preferably 1.7, and more preferably 2.0.

The slenderness of an elongate sipe is the ratio of the maximum dimension of the elongate sipe in the slenderness direction of the elongate sipe to the maximum dimension of the elongate sipe in a direction perpendicular to the slenderness direction of the elongate sipe. Obviously, the dimensions are considered in the same plane.

In preferred embodiments, the ratio of:
the curvilinear length of the one or each elongation portion; to
the curvilinear length of the central portion,
   is less than or equal to 0.7, preferably to 0.5.

In advantageous but optional embodiments, the first and second blind ends and the first and second dimensioning points defining the slenderness direction of the elongate sipe are arranged so as to define first and second elongation portions, respectively arranged between each first and second dimensioning point defining the slenderness direction of the elongate sipe and each first and second blind end,

the central portion and each first and second elongation portion being arranged such that, when moving along the elongate sipe from each first and second elongation portion towards the central portion, the direction of movement is changed with respect to the slenderness direction of the elongate sipe when respectively passing through each first and second dimensioning point of the elongate sipe defining the slenderness direction of the elongate sipe;
the ratio of:
the curvilinear length of each first and second elongation portion; to
the curvilinear length of the central portion,
   is strictly less than 1.0.

Thus, the sipe is elongated from each first and second dimensioning point, which allows the elongate sipe to be rendered even less sensitive to the appearance of cracks and chunking.

In preferred variants, the ratio of:
the curvilinear length of each first and second elongation portion; to
the curvilinear length of the central portion, is less than or equal to 0.7, preferably to 0.5.

In embodiments for using simple manufacturing methods and tools for the elongate sipe, the central portion is arranged such that, when moving along the elongate sipe in the central portion from the first dimensioning point defining the slenderness direction of the elongate sipe to the second dimensioning point defining the slenderness direction of the elongate sipe, the direction of movement is not changed with respect to the slenderness direction of the elongate sipe.

In embodiments for using simple manufacturing methods and tools for the elongate sipe, the one or each elongation portion is arranged such that, when moving along the elongate sipe in said elongation portion from said dimensioning point defining the slenderness direction of the elongate sipe to the nearest blind end by moving along the elongate sipe, the direction of movement is not changed with respect to the slenderness direction of the elongate sipe.

In the embodiments in which the elongate sipe comprises first and second elongation portions:
the first elongation portion is preferably arranged such that, when moving along the elongate sipe in the first elongation portion from the first dimensioning point defining the slenderness direction of the elongate sipe to the first blind end, the direction of movement is not changed with respect to the slenderness direction of the elongate sipe; and/or
the second elongation portion is preferably arranged such that, when moving along the elongate sipe in the second elongation portion from the second dimensioning point defining the slenderness direction of the elongate sipe to the second blind end, the direction of movement is not changed with respect to the slenderness direction of the elongate sipe.

In advantageous but optional embodiments, the one or each elongation portion extends in an elongation direction, the elongation direction of the one or each elongation portion and the slenderness direction of the elongate sipe form an angle that is less than or equal to 80°, preferably ranging from 30° to 70° and more preferably ranging from 30° to 50°.

Thus, edges are created in significantly different directions, which allows the transmission of forces to be improved and allows the driveability of the tyre both in a straight line and in a bend to be enhanced, irrespective of the orientation of the tread block in which the elongate sipe is provided.

Each elongation direction is the straight line connecting the blind end of the elongation portion and the dimensioning point that is closest thereto when moving along the elongate sipe from the one or each elongation portion to the central portion.

In advantageous but optional embodiments, the average slenderness direction of the tread block and the slenderness direction of the elongate sipe form an angle that is less than or equal to 45°, preferably to 30°, more preferably to 15° and even more preferably to 5°.

Thus, the transmission of the forces and the driveability of the tyre is maximized. Indeed, the more the direction of the forces is parallel to the slenderness direction of the tread block, the better the transmission of the forces and the driveability of the tyre. However, when the tread block is too large in the direction of the forces, the tyre tends to lose grip with the ground. By providing the elongate sipe such that the slenderness direction of the sipe is as close as possible to the slenderness direction of the tread block, the probability that the ground encounters an edge of the sipe when the tyre is rolling is increased and the probability of a loss of grip between the tread block and the ground is therefore reduced.

In the case of a tread block that is slender in the circumferential direction, the slenderness line of the tread block is the straight or curved line joining the two leading and trailing edges and equidistant from the side edges joining the leading and trailing edges. In the case of a tread block that is slender in the transverse direction, the slenderness line of the tread block is the straight or curved line joining the side edges joining the leading and trailing edges and equidistant from the leading and trailing edges. In order to determine whether a tread block is slender in the circumferential or transverse direction, the tread block is inscribed in a quadrilateral, two of the sides of which are parallel to the axial direction and the other two sides of which are parallel to the circumferential direction. If the two sides parallel to the axial direction are larger than the two sides parallel to the circumferential direction, the tread block is considered to be slender in the transverse direction. If the two sides parallel to the axial direction are smaller than the two sides parallel to the circumferential direction, the tread block is considered to be slender in the circumferential direction.

In the case of a tread block that is slender in the circumferential direction, the average slenderness direction is the straight line passing through the intersection points between the straight or curved slenderness line and the two leading and trailing edges that it crosses. In the case of a tread block that is slender in the transverse direction, the average slenderness direction is the straight line passing through the intersection points between the straight or curved slenderness line and the two side edges that it crosses.

In advantageous but optional embodiments, the ratio of:
the distance in the average slenderness direction of the tread block between the first and second dimensioning points of the elongate sipe defining the slenderness direction of the elongate sipe; to
the distance in the average slenderness direction of the tread block between the first and second dimensioning points of the tread block, is greater than or equal to 0.5, preferably to 0.7.

The elongate sipe, notably the central portion, thus extends over a significant portion of the tread block, which allows, for the reasons explained above, the transmission of the forces and the driveability of the tyre to be maximized in the slenderness direction of the tread block.

The first and second dimensioning points of the tread block in the slenderness direction are such that the tread block is inscribed between first and second straight lines that are substantially parallel to each other and respectively pass through each first and second dimensioning point, with these first and second straight lines being perpendicular to the slenderness direction of the tread block.

In advantageous but optional embodiments, the ratio of:
the distance in a direction perpendicular to the average slenderness direction of the tread block between first and second dimensioning points of the elongate sipe in the direction perpendicular to the average slenderness direction of the tread block; to
the distance in the direction perpendicular to the average slenderness direction of the tread block between first and second dimensioning points of the tread block in the direction perpendicular to the average slenderness direction of the tread block,
   is greater than or equal to 0.3, preferably to 0.5.

The elongate sipe, notably the elongation portion, thus extends over a significant portion of the tread block, which allows, for the reasons explained above, the transmission of the forces and the driveability of the tyre to be maximized in the direction perpendicular to the slenderness direction of the tread block.

The first and second dimensioning points of the sipe in the direction perpendicular to the average slenderness direction of the tread block are such that the sipe is inscribed between first and second straight lines that are substantially parallel to each other and respectively pass through each first and second dimensioning point, with these first and second straight lines being parallel to the slenderness direction of the tread block.

Similarly, the first and second dimensioning points of the tread block in the direction perpendicular to the average slenderness direction of the tread block are such that the tread block is inscribed between first and second straight lines that are substantially parallel to each other and respectively pass through each first and second dimensioning point, with these first and second straight lines being parallel to the slenderness direction of the tread block.

In advantageous but optional embodiments, the ratio of:
the curvilinear length of the one or each elongation portion; to
the curvilinear length of the central portion,
   is greater than or equal to 0.1, preferably to 0.2 and more preferably ranges from 0.2 to 0.5.

Thus, this ensures that the one or each blind end is not too close to an edge of the tread block and does not, in turn, risk causing any cracks.

Preferably, in order to reduce the risk of cracking and chunking, the one or each tread block comprises a single sipe, with the single sipe being the elongate sipe.

Thus, the tread block does not include any sipe, which may or may not be elongate, other than the elongate sipe.

In order to reduce the sensitivity of a large number of tread blocks to the appearance of cracks and chunking, at least 20%, preferably at least 30%, of the number of tread blocks on the tread includes an elongate sipe. A person skilled in the art will know how to determine the tread blocks on which it is most worthwhile implementing the invention by performing successive tests.

Advantageously, at least 50%, preferably 75% and more preferably 100% of the number of tread blocks having a circumferential slenderness include an elongate sipe.

Advantageously, the depth of the one or each elongate sipe is greater than or equal to 50%, preferably to 70% and more preferably to 90% of the height of the one or each tread block in which the one or each elongate sipe is provided.

Advantageously, the depth of the one or each elongate sipe is greater than or equal to 9 mm, preferably ranging from 10 to 14 mm. In some variants, the depth is substantially constant. In other variants, the depth is variable and, more preferably, the depth of the one or each elongation portion is less than the depth of the central portion.

Advantageously, the width of the one or each elongate sipe is less than or equal to 2.0 mm, preferably ranging from 0.5 mm to 2.0 mm.

The features indicated above characterize the tyre when it is new.

A further aim of the invention is the use of a tyre as defined above for racing, preferably for rally racing and more preferably for rally racing at least on rocky and/or gravelly and/or muddy ground and very preferably for rally racing on rocky ground.

The invention will be better understood upon reading the following description, which is provided solely by way of a non-limiting example and with reference to the drawings, in which:

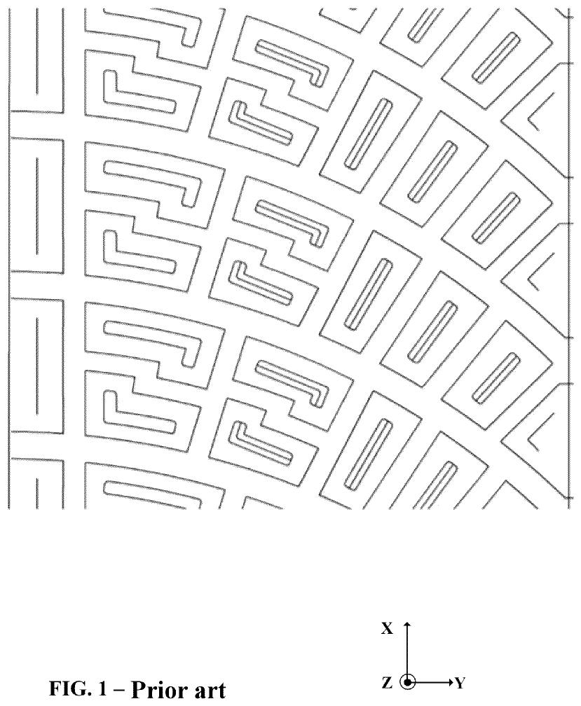

FIG. 1 is a schematic top view of a tread of the tyre of the prior art, namely, MICHELIN LATITUDE CROSS®;

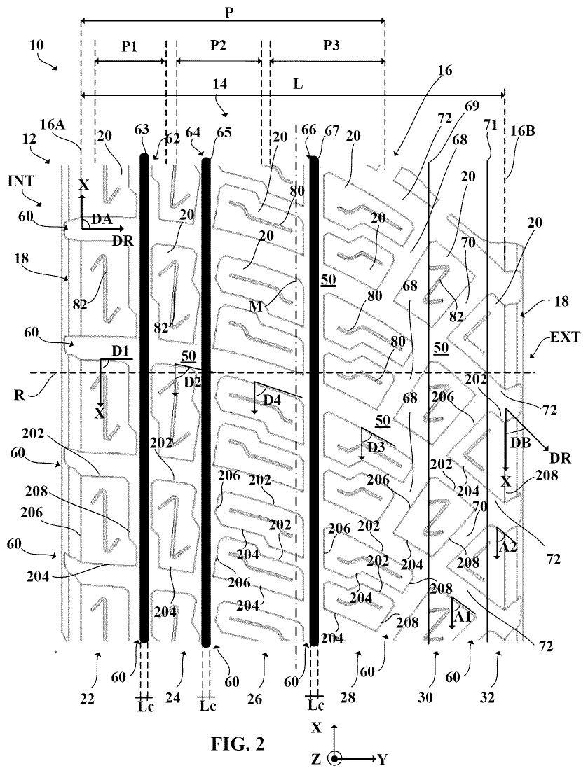

FIG. 2 is a top view of a tyre according to the invention;

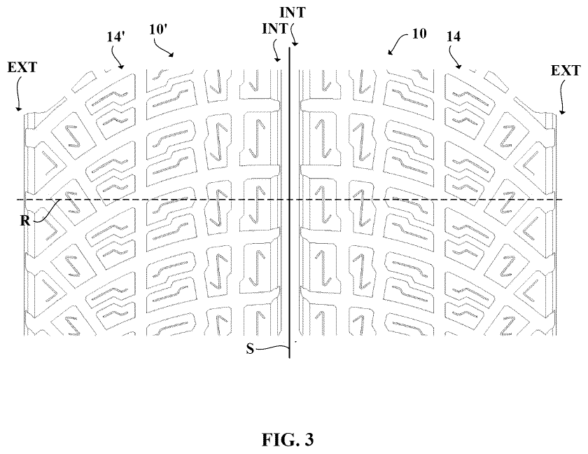

FIG. 3 is a top view of a pair of a first and a second tyre according to the invention;

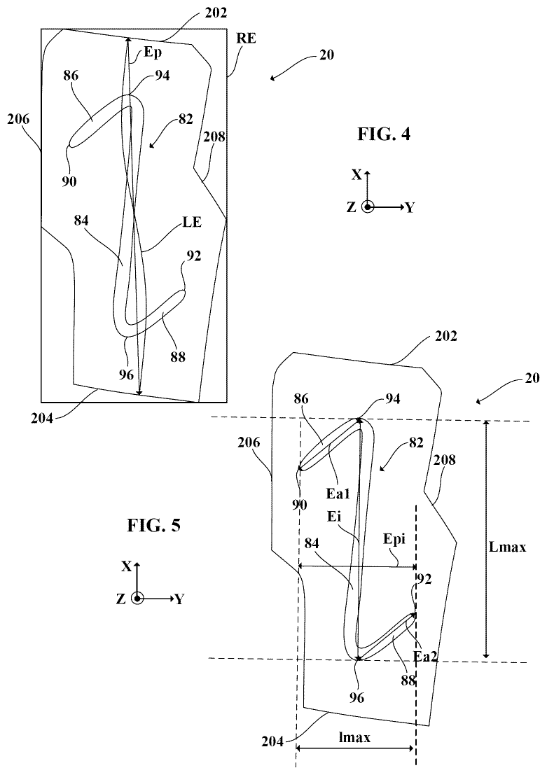

FIGS. 4 to 8 are detail views of the same tread block of the tread of the tyre of FIG. 2; and

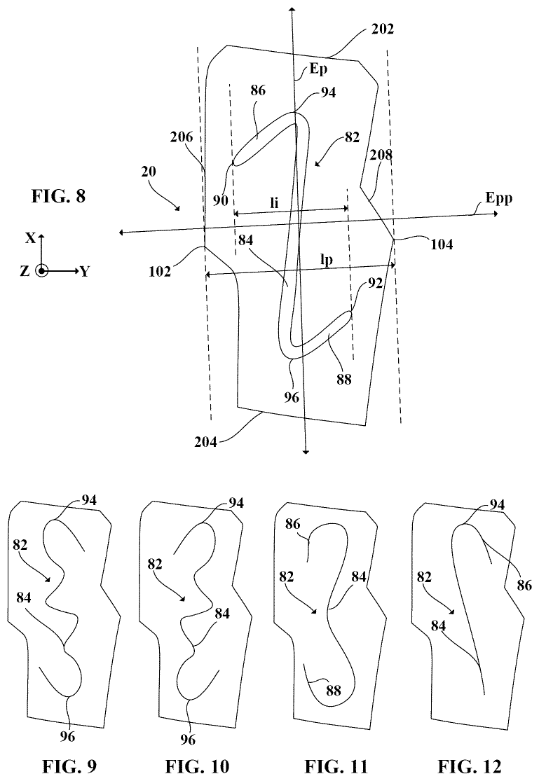

FIGS. 9 to 12 are detail views of tread blocks according to various embodiments.

An X, Y, Z frame of reference corresponding to the usual axial (Y), radial (Z) and circumferential (X) directions, respectively, of a tyre is shown in the figures.

FIG. 2 shows a tyre according to the invention and denoted using general reference sign 10. The tyre 10 has a substantially toroidal shape about an axis of revolution R substantially parallel to the axial direction Y. The dimensions of the tyre 10 are 17/65 R15 and it is intended for racing use, in this case for rally racing and more preferably for rally racing at least on rocky and/or gravelly and/or muddy ground and very preferably for rally racing on rocky ground. The value “17” relates to the theoretical width of the tread, which in this case is 17 cm, the value “65” relates to the theoretical diameter of the tyre, which in this case is 65 cm, and the value “R15” characterizes a radial tyre designed to be fitted on a 15 inch rim. In the various figures, the tyre 10 is shown in new condition, i.e., when it has not yet run.

The tyre 10 comprises a crown 12 comprising a tread 14 intended to come into contact with the ground via a tread surface 16 when the tyre is running. The tread 14 comprises and is delimited by first and second axial edges 16A and 16B defining an axial width L of the tread surface 16. In this case, L=178 mm. The tyre 10 has an inner side INT and an outer side EXT, which are imposed when the tyre 10 is fitted on a vehicle. The first axial edge 16A is arranged on the inner side INT and the second axial edge 16B is arranged on the outer side EXT.

The tyre 10 comprises two sidewalls 18 that extend the crown 12 radially inwards. The tyre 10 further comprises two beads (not illustrated) radially on the inside of the sidewalls 18 and intended to allow the tyre 10 to be attached to a mounting support, for example, a rim. Each sidewall 18 connects each bead to the crown 12.

The tread 14 comprises a plurality of tread blocks 20 and a plurality of cuts 50 delimiting the plurality of tread blocks 20. The plurality of cuts 50 comprises a plurality of grooves 60 and a plurality of sipes 80.

The plurality of grooves 60 comprises first, second and third circumferential grooves 62, 64, 66 arranged such that there is at least one first, second and third substantially circumferential line 63, 65, 67 passing through each first, second and third circumferential groove 62, 64, 66, respectively, and continuously extending around a circumference of the tyre without intersecting any tread block of the plurality of tread blocks 20. Each first, second and third substantially circumferential line 63, 65, 67 has an axial width Lc that is greater than or equal to 2 mm, preferably greater than or equal to 5 mm and in this case greater than or equal to 7 mm.

The first circumferential groove 62 is the circumferential groove from among the first, second and third circumferential grooves 62, 64, 66 arranged axially closest to the first axial edge 16A. The third circumferential groove 66 is the circumferential groove from among the first, second and third circumferential grooves 62, 64, 66 arranged axially closest to the second axial edge 16B. The second circumferential groove 64 is axially arranged between the first circumferential groove 62 and the third circumferential groove 66.

Each first, second and third circumferential groove 62, 64, 66 is arranged in an axial portion with an axial width P that is equal to at most 75%, preferably at most 70%, of the axial width L of the tread 14 and extending from the first axial edge 16A.

More specifically, the first circumferential groove 62 is axially arranged in a first axial portion P1 axially extending between axial limits at 3% and 25%, preferably at 5% and 20 %, of the axial width L of the tread 14 from the first axial edge 16A. The second circumferential groove 64 is axially arranged in a second axial portion P2 axially extending between axial limits arranged at 19% and 42%, preferably at 23% and 39%, of the axial width L of the tread 14 from the first axial edge 16A. The third circumferential groove 66 is axially arranged in a third axial portion P3 axially extending between axial limits arranged at 42% and 70%, preferably at 46% and 66%, of the axial width L of the tread 14 from the first axial edge 16A.

The plurality of grooves 60 also comprises transverse grooves 72 continuously extending from the first axial edge 16A to the second axial edge 16B of the tread 14. The transverse grooves 72 extend substantially parallel to one another. Each transverse groove 72 axially extends in an axially variable main direction. Each transverse groove 72 crosses each first, second and third circumferential groove 62, 64, 66.

The angle formed by the main direction of each transverse groove 72 and the circumferential direction X is constant over an axial portion axially extending from the first axial edge 16A and the first circumferential line 63 and exhibits a non-zero monotonous variation, which in this case strictly decreases, over an additional axial portion axially extending from the first circumferential line 63 and the second axial edge 16B. In addition, the angle DA formed by the main direction DR of each transverse groove 72 and the circumferential direction X of the tyre at the first axial edge 16A is greater than the angle DB formed by the main direction DR of each transverse groove 72 and the circumferential direction X at the second axial edge 16B. The angle DA ranges between 70° and 90° and in this case is substantially equal to 90°. The angle DB ranges between 30° and 60° and in this case is substantially equal to 50°.

The plurality of tread blocks 20 comprises first, second, third and fourth circumferential columns of tread blocks 20 of the plurality of tread blocks 20, denoted by reference signs 22, 24, 28, 26, respectively, as well as first and second additional circumferential columns 30, 32 of tread blocks 20 of the plurality of tread blocks 20. The first and second additional circumferential columns 30, 32 of tread blocks 20 are separate from the first, second, third and fourth circumferential columns 22, 24, 28, 26 of tread blocks 20. Each additional circumferential column 30, 32 is axially closer to the second axial edge than the first, second and third circumferential columns 22, 24, 28, 26. The first circumferential column 22 of tread blocks 20 is the column of tread blocks from among the first, second and third circumferential columns 22, 24, 26 of tread blocks arranged axially closest to the first axial edge 16A. The third circumferential column 28 is the column of tread blocks from among the first, second, third and fourth circumferential columns 22, 24, 28, 26 of tread blocks arranged axially closest to the second axial edge 16B. The second circumferential column 24 is axially arranged between the first circumferential column 22 and the third circumferential column 28. The fourth circumferential column 26 is axially arranged between the second circumferential column 24 and the third circumferential column 28.

Each tread block 20 of the first circumferential column 22 is axially delimited by the first circumferential groove 62 and the first axial edge 16A. Each tread block 20 of the second circumferential column 24 is axially delimited by the first and second circumferential grooves 62, 64. Each tread block 20 of the third circumferential column 28 is at least partially axially delimited by the third circumferential groove 66. Each tread block 20 of the fourth circumferential column 26 is axially delimited by the second and third circumferential grooves 64, 66.

Each first and second circumferential column 22, 24 comprises a single tread block 20 between two circumferentially consecutive transverse grooves 72. Each third and fourth circumferential column 28, 26 comprises at least two tread blocks 20, preferably only two tread blocks 20, between two circumferentially consecutive transverse grooves 72.

Each first and second additional circumferential column 30, 32 of tread blocks 20 is axially arranged on the outside of the third circumferential column 28. The second additional circumferential column 32 is axially arranged on the outside of the first additional circumferential column 30.

Each tread block 20 of the first additional circumferential column 30 is axially delimited by two oblique grooves 68, 70 crossing two circumferentially consecutive transverse grooves 72. Each tread block 20 of the second additional circumferential column 32 of tread blocks is axially delimited by an oblique groove 70 crossing two circumferentially consecutive transverse grooves 72 and the second axial edge 16B.

FIG. 2 shows two circumferential lines 69, 71 passing through each oblique groove 68, 70. Each of these circumferential lines 69, 71 necessarily intersects the tread blocks 20 of each first and second additional circumferential column 30, 32, respectively. Thus, more generally, each tread block 20 of each first and second additional circumferential column 30, 32 is arranged such that there is no substantially circumferential line continuously extending around a circumference of the tyre and passing through each oblique groove 68, 70 delimiting each tread block of each first and second additional circumferential column 30, 32 of tread blocks, without intersecting the tread blocks 20 of each first and second additional circumferential column 30, 32, respectively.

Each first and second additional circumferential column 30, 32 comprises a single tread block 20 between two circumferentially consecutive transverse grooves 72.

Each tread block 20 of the plurality of tread blocks 20 comprises a plurality of edges defining a contour, in this case a substantially polygonal contour. Each tread block 20 of each first, second, third and fourth circumferential column 22, 24, 28, 26 and of each first and second additional circumferential column 30, 32 comprises a leading edge 202, a trailing edge 204 and side edges 206, 208.

The leading edge 202 of each tread block 20 of each first, second, third and fourth circumferential column 22, 24, 28, 26 has an average direction respectively forming an angle D1, D2, D3, D4 with the circumferential direction X that is strictly greater than the angle A1, A2 formed by the average direction of the leading edge 202 of each tread block 20 of each first and second additional circumferential column 30, 32, respectively, with the circumferential direction X.

The angle D1, D2, D4, D3, A1, A2 formed by the average direction of the leading edge 202 of each tread block 20 of each circumferential column 22, 24, 26, 28, 30, 32 with the circumferential direction X is strictly greater than the angle D2, D4, D3, A1, A2 formed, with the circumferential direction X, by the average direction of the leading edge 202 of each tread block 20 of the circumferential column 24, 26, 28, 30, 32 that is axially adjacent thereto, with each column 24, 26, 28, 30, 32 axially adjacent to a given circumferential column 22, 24, 26, 28, 30, 32 being closer to the outer side EXT than each corresponding given circumferential column 22, 24, 26, 28, 30, 32.

The leading edge 202 of 100% of the tread blocks 20 of each third and fourth circumferential column 28, 26 has a curvilinear length that is strictly greater than the curvilinear length of each lateral edge 206, 208 of said tread block 20.

Each angle D1, D2, D3, D 4 is greater than or equal to 50°, preferably greater than or equal to 60°. The angle D1 is greater than or equal to the angle D2. The angle D2 is strictly greater than the angle D3. The angle D4 is strictly greater than the angle D3. In this particular instance, each angle D1, D2 ranges from 70° to 90°, the angle D3 ranges from 50° to 70°, and the angle D4 ranges from 65° to 85°. D1=90°, D2=85°, D3 =60°and D4=75°.

Each angle A1, A2 is less than or equal to 60°, preferably less than or equal to 50°. The angle A1 is strictly greater than the angle A2. In this particular instance, each angle A1, A2 ranges from 30° to 60°. A1=45° and A2=40°.

The width of each first, second and third circumferential groove 62, 64, 66 is greater than or equal to 2 mm, preferably ranging from 5 mm to 15 mm and more preferably ranging from 7 mm to 12 mm, and in this case is equal to 9.7 mm, 8.7 mm and 9.7 mm, respectively. The width of each transverse groove 72 is greater than or equal to 2 mm, preferably ranging from 5 mm to 15 mm and more preferably ranging from 7 mm to 12 mm, and in this case is equal to 9.6 mm. The width of each oblique groove 68, 70 is greater than or equal to 2 mm, preferably ranging from 5 mm to 15 mm and more preferably ranging from 7 mm to 12 mm, and in this case is equal to 10 mm.

The void ratio by area of the tread 14 that is associated with the grooves with a width that is greater than or equal to 2 mm, preferably 4 mm, in this case associated with the circumferential grooves 62, 64, 66, with the transverse grooves 72 and with the oblique grooves 68, 70, ranges from 35% to 55%, preferably from 40% to 50%, and in this case is equal to 44%. The void ratio by volume of the tread that is associated with the grooves with a width that is greater than or equal to 2 mm, preferably 4 mm, in this case associated with the circumferential grooves 62, 64, 66, with the transverse grooves 72 and with the oblique grooves 68, 70, ranges from 30 % to 45 %, preferably from 35 % to 45 %, and in this case is equal to 39 %.

The tread pattern height is greater than or equal to 7 mm, preferably ranging from 9 mm to 16 mm, and in this case is equal to 12 mm.

With reference to FIG. 3, a pair 100 of a first and a second tyre 10, 10′ is shown, with both tyres being tyres according to the invention. The tread 14 of the first tyre 10 is symmetrical to the tread 14′ of the second tyre 10′ with respect to a plane of symmetry S substantially perpendicular to an axis of rotation R common to the first and second tyres 10, 10′. In the example of FIG. 3, the first tyre 10 is intended to be fitted on the right-hand side of a vehicle, whereas the second tyre 10′ is intended to be fitted on the left-hand side of a vehicle, such that the inner side INT of each first and second tyre 10, 10′ faces the wheel arch of the vehicle and such that the outer side EXT of each first and second tyre 10, 10′ is fully visible from the outside of the vehicle when the tyre is fitted on the vehicle.

With reference to FIG. 2, each tread block 20 of the tread 14 comprises a single sipe 80. Each tread block 20 of each first and second circumferential column 22, 24 and of the additional circumferential column 30 comprises a sipe 82, called elongate sipe, and in this case a single elongate sipe 82.

A detailed description of a tread block 20 of the second circumferential column 24 of tread blocks and the elongate sipe 82 provided therein will now be provided with reference to FIGS. 4 and 5.

With reference to FIG. 4, each tread block 20 of the second circumferential column 24 is slender in the circumferential direction X. Indeed, each tread block 20 of the second circumferential column 24 is inscribed in a rectangle RE, two sides of which are parallel to the axial direction Y and two other sides of which are parallel to the circumferential direction X. Since the two sides that are parallel to the axial direction Y are smaller than the two sides that are parallel to the circumferential direction X, each tread block 20 of the second circumferential column 24 is slender in the circumferential direction X. The slenderness line LE of each tread block 20 of the second circumferential column 24 is the curved line joining the two leading 202 and trailing 204 edges, and is equidistant from the side edges 206, 208 joining the leading 202 and trailing 204 edges. The average slenderness direction Ep is the straight line that passes through the intersection points between the curved slenderness line and the two leading 202 and trailing 204 edges that it crosses.

The circumferential length of each tread block 20 of the second circumferential column 24, i.e., in this case, the length of the two sides parallel to the circumferential direction X, is equal to 40 mm. The width of each tread block 20 of the second circumferential column 24, i.e., in this case, the length of the two sides parallel to the axial direction Y, is equal to 22 mm.

The depth of each elongate sipe 82 is greater than or equal to 9 mm, preferably ranging from 10 to 14 mm and in this case is equal to 12 mm. This depth is greater than or equal to 50%, preferably 70% and more preferably 90% of the height of the tread block 20 in which said elongate sipe 82 is provided. In this case, the height of each tread block 20 of the second circumferential column 24 is substantially equal to 12 mm. The width of each elongate sipe 82 is less than or equal to 2.0 mm, preferably ranging from 0.5 mm to 2.0 mm and in this case is equal to 1.0 mm.

Each elongate sipe 82 comprises a central portion 84 and first and second elongation portions 86, 88, with each first and second elongation portion 86, 88 being connected to the central portion 84. Each elongate sipe 82 also comprises first and second blind ends 90, 92, as well as first and second dimensioning points 94, 96 arranged so as to define, on the one hand, the central portion 84 arranged between the first and second dimensioning points 94, 96 and, on the other hand, each first and second elongation portion 86, 88 respectively arranged between each first and second dimensioning point 94, 96 and each first and second blind end 90, 92. Each first and second dimensioning point 94, 96 is respectively separate from each first and second blind end 90, 92.

The curvilinear length of each first and second elongation portion 86, 88, i.e., the curvilinear length between each first and second dimensioning point 94, 96 and each first and second blind end 90, 92, respectively, in this case is equal to 8 mm. The curvilinear length of the central portion 84, i.e., the curvilinear length between each first and second dimensioning point 94, 96, in this case is equal to 30 mm. Thus, the ratio of the curvilinear length of each first and second elongation portion 86, 88 to the curvilinear length of the central portion 84 is strictly less than 1.0, preferably less than or equal to 0.7, preferably 0.5 and is greater than or equal to 0.1, preferably 0.2 and more preferably ranges from 0.2 to 0.5, and in this case is equal to 0.27.

With reference to FIG. 5, the first and second dimensioning points 94, 96 define a slenderness direction Ei of the elongate sipe 82 and a maximum dimension Lmax of the elongate sipe 82 in the slenderness direction Ei of the elongate sipe 82 and a maximum dimension Imax of the elongate sipe 82 in a direction Epi perpendicular to the slenderness direction Ei. In general, it should be noted that the slenderness direction Ei of the elongate sipe 82 coincides with the slenderness direction of the central portion 84. Each first and second elongation portion 86, 88 extends in an elongation direction Ea1, Ea2. In this case, Lmax=31 mm, Imax=10 mm, such that the slenderness of the elongate sipe 82 is greater than or equal to 1.5, preferably to 1.7 and more preferably to 2.0, and in this case is equal to 3.1.

Each elongation direction Ea1, Ea2 of each first and second elongation portion 86, 88 and the slenderness direction Ei of the elongate sipe 82 form an angle that is less than or equal to 80°, preferably ranging from 30° to 70°, more preferably ranging from 30° to 50°, and in this case is equal to 37°.

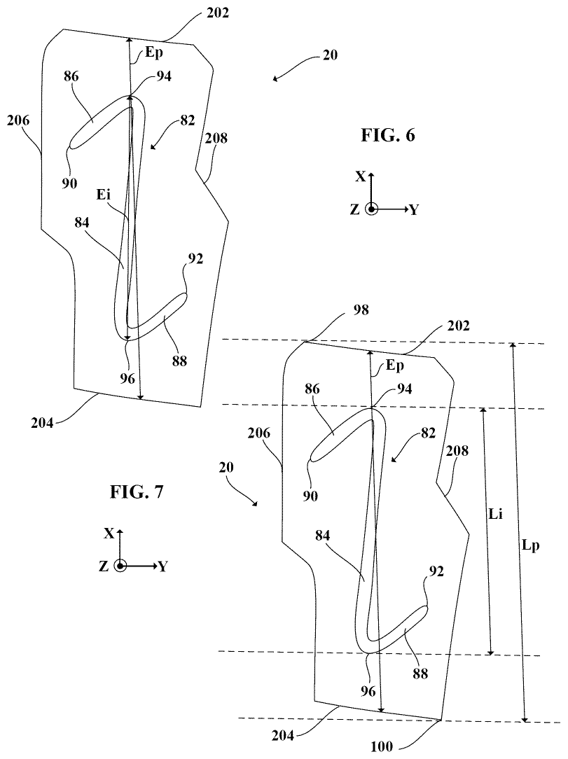

With reference to FIG. 6, the average slenderness direction Ep of the tread block 20 and the slenderness direction Ei of the elongate sipe 82 form an angle that is less than or equal to 45°, preferably to 30°, more preferably to 15°, and even more preferably to 5°.

With reference to FIG. 7, the distance Li between the first and second dimensioning points 94, 96 of the elongate sipe 82 in the average slenderness direction Ep of the tread block 20 in this case is equal to 31 mm and the distance Lp between the first and second dimensioning points 98, 100 of the tread block 20 in the average slenderness direction Ep of the tread block 20 in this case is equal to 41 mm. The ratio of Li to Lp is greater than or equal to 0.5, preferably to 0.7, and in this case is equal to 0.76.

With reference to FIG. 8, the elongate sipe 82 has first and second dimensioning points of the elongate sipe 82 in a direction Epp perpendicular to the average slenderness direction Ep of the tread block 20. In this case, each first and second dimensioning point of the elongate sipe 82 in the direction Epp coincides with each first and second blind end 90, 92, respectively. The distance li between the first and second dimensioning points 90, 92 of the elongate sipe 82 in the direction Epp is equal to 11 mm. The tread block 20 has first and second dimensioning points 102, 104 of the tread block 20 in the direction Epp. The distance Ip between the first and second dimensioning points 102, 104 of the tread block 20 in the direction Epp is equal to 22 mm. The ratio of li to Ip is greater than or equal to 0.3, preferably to 0.5, and in this case is equal to 0.5.

With reference to FIG. 5, the central portion 84 and each first and second elongation portion 86, 88 are arranged such that, when moving along the elongate sipe 82 from each first and second elongation portion 86, 88 to the central portion 84, there is a change in the direction of movement with respect to the slenderness direction Ei of the elongate sipe 82 when respectively passing through each first and second dimensioning point 94, 96 of the elongate sipe 82.

The central portion 84 is arranged such that, when moving along the elongate sipe 82 in the central portion 84 from the first dimensioning point 94 to the second dimensioning point 96, the direction of movement is not changed with respect to the slenderness direction Ei of the elongate sipe 82.

The first elongation portion 86 is arranged such that, when moving along the elongate sipe 82 in the first elongation portion 86 from the first dimensioning point 94 to the first blind end 90, the direction of movement is not changed with respect to the slenderness direction Ei. Similarly, the second elongation portion 88 is arranged such that, when moving along the elongate sipe 82 in the second elongation portion 88 from the second dimensioning point 96 defining the slenderness direction Ei to the second blind end 92, the direction of movement is not changed with respect to the slenderness direction Ei.

With further reference to FIG. 2, it can be seen that at least 20%, preferably at least 30%, and in this case 50% of the number of tread blocks of the tread includes an elongate sipe 82, in this case the tread blocks 20 of the circumferential columns 22, 24 and 30. At least 50%, preferably 75% of the number of tread blocks have a circumferential slenderness, i.e., in this case at least 50%, preferably 75% of the number of tread blocks 20 of the circumferential columns 22, 24, 30 and 32 include an elongate sipe 82.

FIGS. 9 to 12 show tread blocks comprising elongate sipes 82 according to other embodiments.

Unlike the elongate sipes 82 described with reference to the preceding figures, the elongate sipes 82 in FIGS. 9 and 10 are such that the central portion 84 is not rectilinear. However, as for the elongate sipes 82 described with reference to the preceding figures, when moving along the elongate sipe 82 in the central portion 84 from the first dimensioning point 94 defining the slenderness direction Ei to the second dimensioning point 96, the direction of movement is not changed with respect to the slenderness direction Ei.

Unlike the elongate sipes 82 described with reference to the preceding figures, the first and second elongate portions 86, 88 are curved in the same direction.

Unlike the elongate sipes 82 described with reference to the preceding figures, the elongate sipe 82 of FIG. 12 includes a single elongation portion 86.

The invention is not limited to the embodiments described above.

1.-12. (canceled)

13. A tire comprising a tread comprising a plurality of tread blocks delimited by a plurality of cuts, at least one tread block of the plurality of tread blocks comprises an elongate sipe, with the elongate sipe being provided in the at least one tread block, the elongate sipe comprising:
first and second blind ends; and
first and second dimensioning points defining a slenderness direction of the elongate sipe and a maximum dimension of the elongate sipe in the slenderness direction of the elongate sipe, each first and second dimensioning point being distinct from each first and second blind end,
the first and second blind ends and the first and second dimensioning points being arranged so as to define:
a central portion of the elongate sipe arranged between the first and second dimensioning points defining the slenderness direction of the elongate sipe; and
at least one elongation portion of the elongate sipe arranged between one of the first and second dimensioning points defining the slenderness direction of the elongate sipe and one of the first and second blind ends, with the at least one elongation portion being connected to the central portion,
wherein the central portion and the at least one elongation portion are arranged such that, when moving along the elongate sipe from the at least one elongation portion towards the central portion, a direction of movement is changed with respect to the slenderness direction of the elongate sipe when passing through the dimensioning point of the elongate sipe defining the slenderness direction of the elongate sipe, and
wherein a ratio of a curvilinear length of the at least one elongation portion to a curvilinear length of the central portion is strictly less than 1.0.

14. The tire according to claim 13, wherein the first and second blind ends and the first and second dimensioning points defining the slenderness direction of the elongate sipe are arranged so as to define first and second elongation portions, respectively arranged between each first and second dimensioning point defining the slenderness direction of the elongate sipe and each first and second blind end,
the central portion and each first and second elongation portion being arranged such that, when moving along the elongate sipe from each first and second elongation portion towards the central portion, the direction of movement is changed with respect to the slenderness direction of the elongate sipe when respectively passing through each first and second dimensioning point of the elongate sipe defining the slenderness direction of the elongate sipe,
wherein the ratio of a curvilinear length of each first and second elongation portion to the curvilinear length of the central portion is strictly less than 1.0.

15. The tire according to claim 13, wherein the central portion is arranged such that, when moving along the elongate sipe in the central portion from the first dimensioning point defining the slenderness direction of the elongate sipe to the second dimensioning point defining the slenderness direction of the elongate sipe, the direction of movement is not changed with respect to the slenderness direction of the elongate sipe.

16. The tire according to claim 13, wherein the at least one elongation portion is arranged such that, when moving along the elongate sipe in the at least one elongation portion from the dimensioning point defining the slenderness direction of the elongate sipe to a nearest blind end by moving along the elongate sipe, the direction of movement is not changed with respect to the slenderness direction of the elongate sipe.

17. The tire according to claim 13, wherein, with the at least one elongation portion extending in an elongation direction, the elongation direction of the at least one elongation portion and the slenderness direction of the elongate sipe form an angle that is less than or equal to 80°.

18. The tire according to claim 13, wherein an average slenderness direction of the at least one tread block and the slenderness direction of the elongate sipe form an angle that is less than or equal to 45°.

19. The tire according to claim 13, wherein a ratio of a distance in an average slenderness direction of the at least one tread block between the first and second dimensioning points of the elongate sipe defining the slenderness direction of the elongate sipe to a distance in the average slenderness direction of the at least one tread block between the first and second dimensioning points of the at least one tread block is greater than or equal to 0.5.

20. The tire according to claim 13, wherein a ratio of a distance in a direction perpendicular to an average slenderness direction of the at least one tread block between the first and second dimensioning points of the elongate sipe in the direction perpendicular to the average slenderness direction of the at least one tread block to a distance in the direction perpendicular to the average slenderness direction of the at least one tread block between the first and second dimensioning points of the at least one tread block in the direction perpendicular to the average slenderness direction of the at least one tread block is greater than or equal to 0.3.

21. The tire according to claim 13, wherein the ratio of the curvilinear length of the at least one elongation portion to the curvilinear length of the central portion is greater than or equal to 0.1.

22. The tire according to claim 13, wherein the at least one tread block comprises a single sipe, the single sipe being the elongate sipe.
